(19) United States
(12) Patent Application Publication
(10) Pub. No.: US 2019/0102693 A1
(43) Pub. Date: Apr. 4, 2019

(54) OPTIMIZING PARAMETERS FOR MACHINE LEARNING MODELS

(71) Applicant: Facebook, Inc., Menlo Park, CA (US)

(72) Inventors: Andrew Donald Yates, San Francisco, CA (US); Gunjit Singh, San Francisco, CA (US); Kurt Dodge Runke, Los Altos, CA (US)

(21) Appl. No.: 15/721,189

(22) Filed: Sep. 29, 2017

(51) Int. Cl. G06N 99/00; G06N 7/00

(52) U.S. Cl. CPC G06N 99/005; G06N 7/005

(57) ABSTRACT

An online system determines candidate parameter values to be used by a machine learning algorithm to train a machine learning model by saving historical datasets that include historical parameter searches and the performance of prior machine learning models that were trained on the historical parameters. Using the historical datasets, the online system identifies parameter predictors associated with a relation between candidate parameter values and properties of the training dataset that will be used to train the machine learning model. The online system trains the machine learning models according to the candidate parameter values and validates that the machine learning model is performing as expected. If the online system detects that the machine learning model is performing outside of an acceptable range, the online system determines new candidate parameter values and re-trains the machine learning model.

### TECHNICAL FIELD

This disclosure generally relates to training machine learning models, and more specifically to predicting parameters for training machine learning models using a prediction model.

### BACKGROUND

Machine learning models are widely implemented for a variety of purposes in online systems, for example, to predict the likelihood of the occurrence of an event. Machine learning models can learn to improve predictions over numerous training iterations, often times to accuracies that are difficult to achieve by a human. An important step in the implementation of a machine learning model that can accurately predict an output is the training step of the machine learning model. Specifically, the training of machine learning models uses pre-set parameter values that cannot be learned during the training iterations. In order to determine these parameter values, conventional techniques include naively searching across a parameter space that includes a large number of possible parameter values using search techniques such as exhaustive search, random search, grid search, or Bayesian-Gaussian methods. However, these conventional techniques require significant consumption of resources including time, computational memory, processing power, and the like. For example, certain parameters may not significantly impact the performance of a machine learning model and performing a naïve search of those parameters is inefficient.

### SUMMARY

An online system trains machine learning models for use during production, for example, to predict whether a user of the online system would be interested in a particular content item. The online system predicts model parameter values for training the machine learning models based on historical datasets that include performance of prior machine learning models previously trained using various candidate parameter values. An example model parameter is the learning rate for a gradient boost decision tree based model.

In various embodiments, the online system predicts the candidate model parameter values for training a machine learning model based on properties (or characteristics) of the training dataset being considered for training the machine learning model. For example, given the historical datasets, the online system generates parameter predictors, each parameter predictor describing a relationship between a candidate parameter and a training dataset property. As one example, a parameter predictor may describe the relationship between a learning rate (e.g., candidate parameter) and the total number of training samples (e.g., training dataset properties). Therefore, provided the training data that is to be used to train a machine learning model, the online system predicts the candidate model parameter values using the generated parameter predictors. Altogether, using the parameter predictors, the online system can significantly narrow the parameter space, which is the combination of possible parameter values that can be used to train a machine learning model. Instead of executing a naïve parameter search, which requires significant resources, the online system identifies candidate model parameter values that would likely result in an accurate machine learning model based on historical information corresponding to past parameter searches and on training dataset properties.

In an embodiment, the online system trains machine learning models according to the identified candidate parameter values and uses the trained machine learning models to predict certain events. The online system validates that the trained machine learning models are performing as expected. The online system verifies that the historical datasets used by the prediction model to determine candidate parameter values are applicable datasets. The online system predicts an estimated performance of a machine learning model that is trained using the candidate parameter values. In various embodiments, the online system estimates the performance based on the historical dataset that includes the past performance of trained machine learning models. During production, the online system compares the predicted output (e.g., a predicted occurrence of an event) generated by the machine learning model to an actual output (e.g., an observation of whether the event actually occurred) to determine the performance of the machine learning model. The online system triggers a corrective action if the performance of the machine learning model significantly differs from the estimated performance. The online system may retrain the machine learning model or replace the machine learning model.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 depicts an overall system environment for determining candidate parameter values for training a machine learning model, in accordance with an embodiment.

FIG. 2 shows the details of the model generation module along with the data flow for determining candidate parameter values by the model generation module, in accordance with an embodiment.

FIG. 3 depicts a block diagram flow process for validating the prediction model and trained machine learning model, in accordance with an embodiment.

FIG. 4A depicts an example historical dataset, in accordance with an embodiment.

FIGS. 4B and 4C each depict an example parameter predictor, in accordance with an embodiment.

FIG. 5 depicts an example flow process for training a machine learning model, in accordance with an embodiment.

FIG. 6 depicts an example flow process of determining candidate parameter values for a machine learning model, in accordance with an embodiment.

FIG. 7 depicts an example flow process of validating a trained machine learning model, in accordance with an embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. For example, a letter after a reference numeral, such as “110A,” indicates that the text refers specifically to the element having that particular reference numeral. A reference numeral in the text without a following letter, such as “110,” refers to any or all of the elements in the figures bearing that reference numeral (e.g. “client device 110” in the text refers to reference numerals “client device 110A” and/or “client device 110B” in the figures).

### Overall System Environment

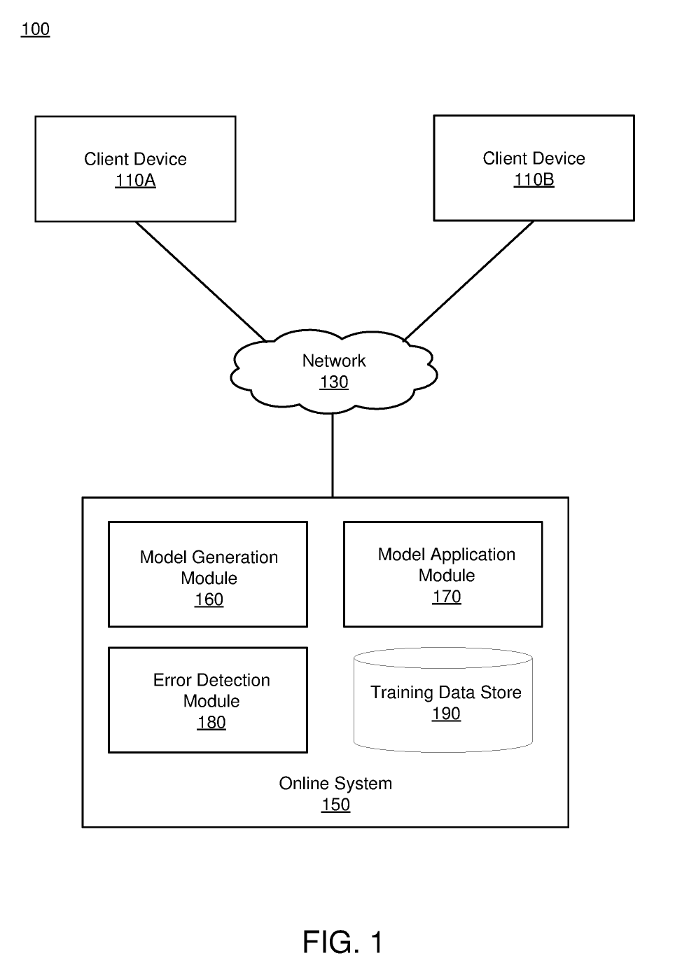

FIG. 1 depicts an overall system environment 100 for determining candidate parameter values for training a machine learning model, in accordance with an embodiment. The system environment 100 can include one or more client devices 110 and an online system 150 interconnected through a network 130.

Client Device

The client device 110 is an electronic device associated with an individual. Client devices 110 can be used by individuals to perform functions such as consuming digital content, executing software applications, browsing websites hosted by web servers on the network 130, downloading files, and interacting with content provided by the online system 150. Examples of a client device 110 includes a personal computer (PC), a desktop computer, a laptop computer, a notebook, a tablet PC executing an operating system, for example, a Microsoft Windows-compatible operating system (OS), Apple OS X, and/or a Linux distribution. In another embodiment, the client device 110 can be any device having computer functionality, such as a personal digital assistant (PDA), mobile telephone, smartphone, etc. The client device 110 may execute instructions (e.g., computer code) stored on a computer-readable storage medium. A client device 110 may include one or more executable applications, such as a web browser, to interact with services and/or content provided by the online system 150. In another scenario, the executable application may be a particular application designed by the online system 150 and locally installed on the client device 110. Although two client devices 110 are illustrated in FIG. 1, in other embodiments the environment 100 may include fewer (e.g., one) or more than two client devices 110. For example, the online system 150 may communicate with millions of client devices 110 through the network 130 and can provide content to each client device 110 to be viewed by the individual associated with the client device 110.

Network

The network 130 facilitates communications between the various client devices 110 and online system 150. The network 130 may be any wired or wireless local area network (LAN) and/or wide area network (WAN), such as an intranet, an extranet, or the Internet. In various embodiments, the network 130 uses standard communication technologies and/or protocols. Examples of technologies used by the network 130 include Ethernet, 802.11, 3G, 4G, 802.16, or any other suitable communication technology. The network 130 may use wireless, wired, or a combination of wireless and wired communication technologies. Examples of protocols used by the network 130 include transmission control protocol/Internet protocol (TCP/IP), hypertext transport protocol (HTTP), simple mail transfer protocol (SMTP), file transfer protocol (TCP), or any other suitable communication protocol.

Online System

The online system 150 trains and applies machine learning models, for example, to predict a likelihood of a user being interested in a content item. The online system 150 selects content items for users by using the machine learning models and provides the content items to users that may be interested in the content items. In training machine learning models, the online system 150 determines candidate parameter values that are used by machine learning algorithms. In various embodiments, the online system 150 determines candidate parameter values using a prediction model. As used hereafter, a prediction model refers to a model that predicts candidate parameter values for use in training a machine learning model. Also as used hereafter, a machine learning model refers to a model that is trained using the values of the candidate parameters predicted by a prediction model. In various embodiments, a machine learning model is used by the online system 150 to predict an occurrence of an event such as a user interaction with a content item presented to a user via a client device (e.g., a user clicking on the content item via a user interface, a conversion based on a content item, such as a transaction performed by a user responsive to viewing the content item, and the like).

In the embodiment shown in FIG. 1, the online system 150 includes a model generation module 160, a model application module 170, and an error detection module 180. In various embodiments, the online system 150 includes a portion of the modules depicted in FIG. 1. For example, the online system 150 may include the model generation module 160 for generating various prediction models but the model application module 170 and error detection module 180 can be embodied in a different system in the system environment 100 (e.g., in a third party system). In this scenario, the online system 150 predicts candidate parameter values and trains machine learning models using the candidate parameter values. The online system 150 can subsequently provide the trained machine learning models to a different system to be entered into production.

In various embodiments, the online system 150 may be a social networking system that enables users of the online system 150 to communicate and interact with one another. In this embodiment, the online system 150 can use information in user profiles, connections between users, and any other suitable information to maintain a social graph of nodes interconnected by edges. Each node in the social graph represents an object associated with the online system 150 that may act on and/or be acted upon by another object associated with the online system 150. An edge between two nodes in the social graph represents a particular kind of connection between the two nodes. An edge may indicate that a particular user of the online system 150 has shown interest in a particular subject matter associated with a node. For example, the user profile may be associated with edges that define a user's activity that includes, but is not limited to, visits to various fan pages, searches for fan pages, liking fan pages, becoming a fan of fan pages, sharing fan pages, liking advertisements, commenting on advertisements, sharing advertisements, joining groups, attending events, checking-in to locations, and buying a product. These are just a few examples of the information that may be stored by and/or associated with a user profile.

In various embodiments, the online system 150 is a social networking system that selects and provides content to users of the social networking system that may be interested in the content. Here, the online system 150 can employ one or more machine learning models for determining whether a user would be interested in a particular content item. For example, the online system 150 can employ a machine learning model that predicts whether a user would interact with a provided content item based on the available user information (e.g., user information stored in a user profile or stored in the social graph). In other words, the online system 150 can provide the user's information to a trained machine learning model to determine whether a user would interact with the content item.

Referring specifically to the individual elements of the online system 150, the model generation module 160 trains a machine learning model using candidate parameter values predicted by a prediction model. In some embodiments, candidate parameters refer to any type of parameters used in training a machine learning model. For example, candidate parameters refer to parameters as well as hyperparameters, i.e., parameters that are not learned from the training process. Examples of hyperparameters include the number of training examples, learning rate, and learning rate decrease rate. In some embodiments, hyperparameters can be feature-specific such as a parameter that weighs the costs of adding a feature to the machine learning model.

In various embodiments, hyperparameters may be specific for a type of machine learning algorithm used to train the machine learning model. For example, if the machine learning algorithm is a deep learning algorithm, hyperparameters include a number of layers, layer size, activation function, and the like. If the machine learning algorithm is a support vector machine, the hyperparameters may include the soft margin constant, regularization, and the like. If the machine learning algorithm is a random forest classifier, the hyperparameters can include the complexity (e.g., depth) of trees in the forest, number of predictors at each node when growing the trees, and the like.

In some embodiments, the model generation module 160 generates a prediction model that identifies candidate parameter values based on 1) historical datasets corresponding to past training parameters and 2) training dataset properties to be used to train the machine learning model. Generally, the prediction model predicts how a machine learning model trained on particular values of parameters would perform based on the historical datasets and properties of the training dataset. The values of parameters that would lead to the best performing machine learning model can be selected as the candidate parameter values.

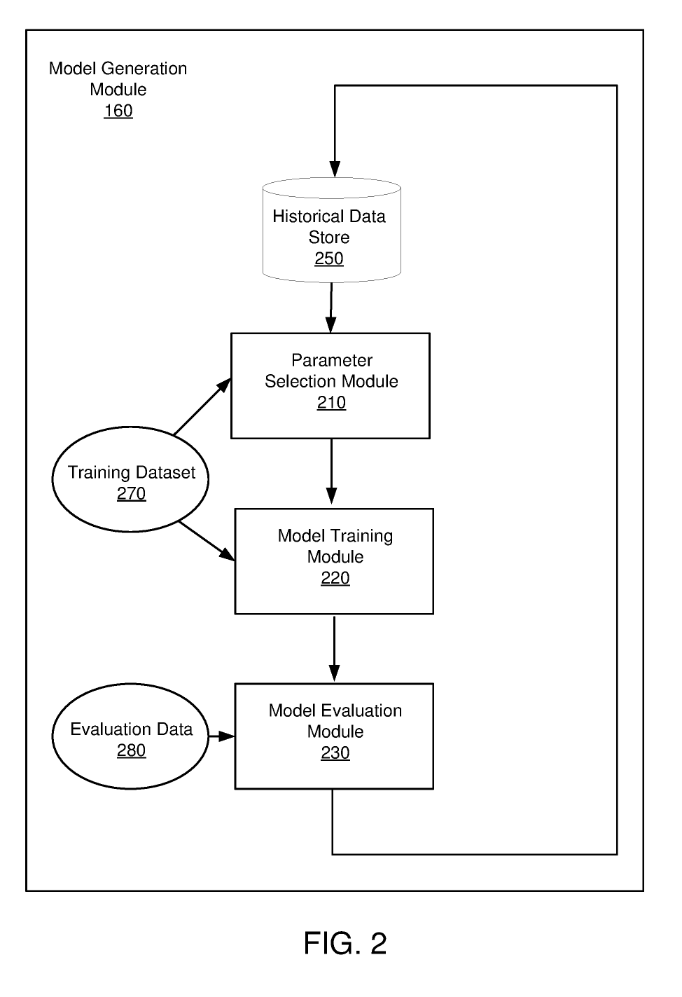

In some embodiments, once the candidate parameter values are identified, the model generation module 160 can tune the candidate parameter values that are then used to train a machine learning model. Here, the process of tuning the candidate parameter values can be performed more effectively (e.g., performed in fewer iterations, thereby conserving time and computer resources such as memory and processing power) in comparison to conventional techniques such as a naïve parameter sweep that represents an exhaustive parameter search through the entire domain of possible parameter values. In various embodiments, the candidate parameter values predicted by the prediction model need not be further tuned. A machine learning model that has been trained using the candidate parameter values can be stored (e.g., in the training data store 190) or provided to the model application module 170 for execution. The model generation module 160 is described in further detail below in reference to FIG. 2.

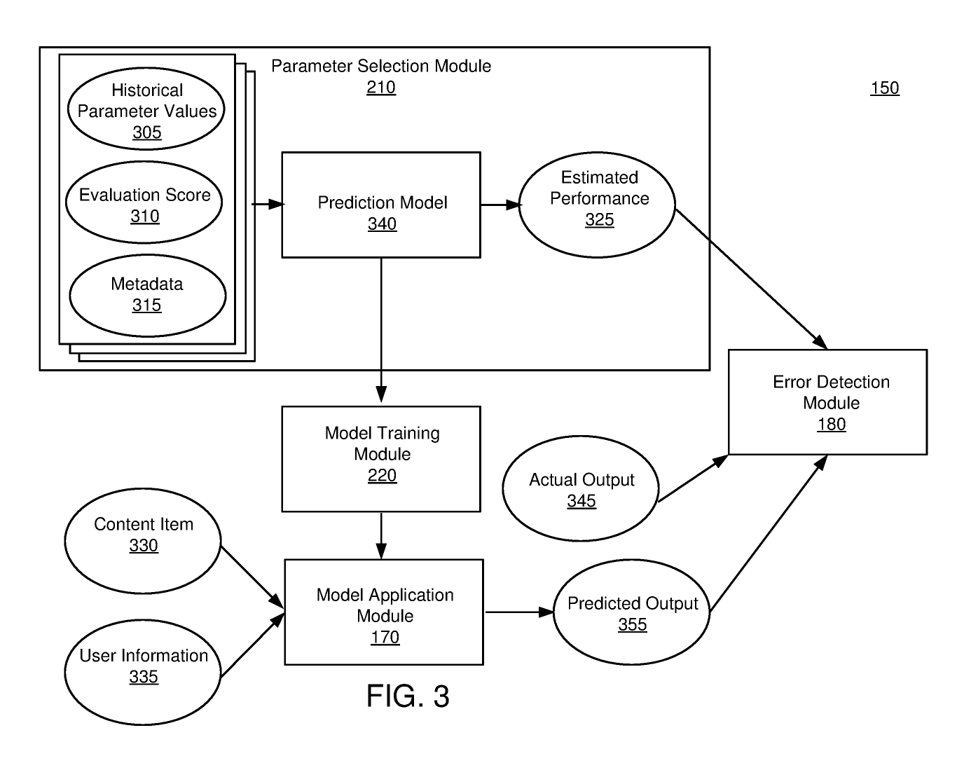

The model application module 170 receives and applies a trained machine learning model to generate a prediction. A prediction output by a trained machine learning model can be used for a variety of purposes. For example, a machine learning model may predict a likelihood that a user of the online system 150 would interact (e.g., click or convert) with a content item presented to the user. In some embodiments, the input to the machine learning model may be attributes describing the content item as well as information about the user of the online system 150 that is stored in the user profile of the user and/or the social graph of the online system 150. In various embodiments, the model application module 170 determines whether to send a content item to the user of the online system 150 based on a score predicted by the trained machine learning model. As one example, if the prediction is above a certain threshold score, thereby indicating a likelihood of the user interacting with the content item, the model application module 170 can then provide the content item to the user. The model application module 170 is described in further detail below in regards to FIG. 3.

The error detection module 180 determines whether a machine learning model trained using candidate parameter values is behaving as expected, and if not, can trigger a corrective action (or corrective measure) such as the re-training of a machine learning model using a new set of candidate parameter values. In various embodiments, the error detection module 180 receives, from the model generation module 160, a predicted performance of a machine learning model that is trained using the candidate parameter values. When the trained machine learning model is applied during production, the actual performance of the trained machine learning model can be compared to the estimated performance. In various embodiments, if the difference between the predicted performance and the actual performance of the machine learning model is above a threshold, then the online system determines that the machine learning model is not valid. For example, certain changes in the system may have caused the machine learning model to become outdated. This can arise from changes that render the historical datasets that were used to predict candidate parameters to train the machine learning model no longer applicable.

Accordingly, the error detection module 180 can trigger a corrective action. In some embodiments, the machine learning model is re-trained using a new set of candidate parameter values that are identified through a naïve parameter search. Altogether, the error detection module 180 performs validation of the machine learning model to ensure that the machine learning model is behaving appropriately (i.e., is valid). The error detection module 180 is described in further detail below in FIG. 3.

### Determining Parameters for Prediction Models

FIG. 2 shows the details of the model generation module along with the data flow for determining candidate parameter values by the model generation module, in accordance with an embodiment. In the embodiment shown in FIG. 2, the model generation module 160 may include various components including a parameter selection module 210, a model training module 220, and a model evaluation module 230.

The parameter selection module 210 receives a request to train a machine learning model. In one embodiment, the received request identifies static information of the machine learning model that is to be trained such as an event that is to be predicted and/or an entity that the machine learning model is trained for. The parameter selection module 210 identifies candidate parameter values to be used to train the machine learning model. Once identified, the candidate parameter values are provided by the parameter selection module 210 to the model training module 220. In one embodiment, the parameter selection module 210 randomly selects various sets of candidate parameter values from all possible parameter values (e.g., a large parameter space) for the machine learning model that will be trained using the set of candidate parameter values. The parameter selection module 210 provides the sets of candidate parameters values to the model training module 220. As one example, this embodiment corresponds to the situation in which the historical data store 250 is empty or doesn't have sufficient training data because a new machine learning model is to be trained and as such, no historical data or very little historical data exist. As another example, historical datasets in the historical data store 250 are no longer applicable and therefore, naïve parameters are needed. This may happen if there is some significant change in the configuration of the system thereby making existing historical data irrelevant for subsequent processing. In these embodiments, the parameter selection module 210 may perform one of a grid search or a random parameter search to determine candidate parameter values.

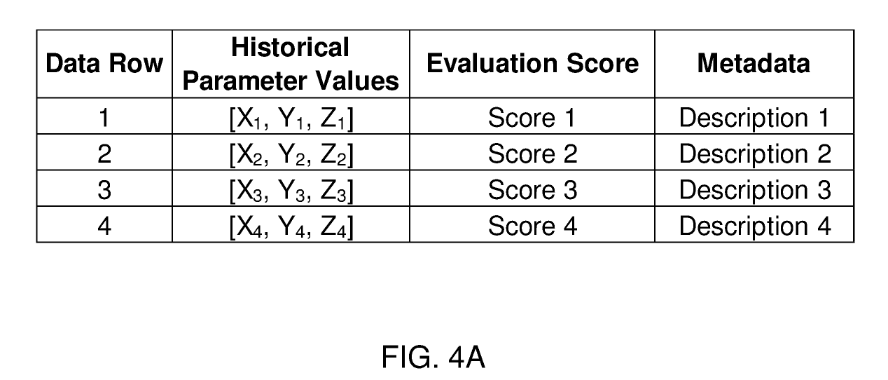

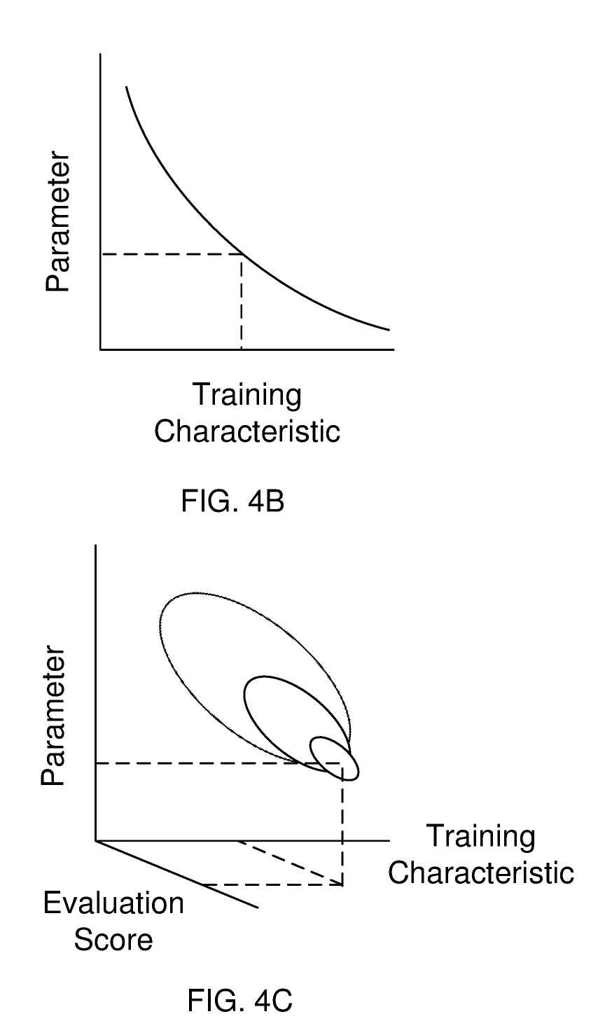

In some embodiments, such as one shown in FIG. 2, the parameter selection module 210 identifies candidate parameter values by retrieving historical datasets from the historical data store 250. Reference is now made to FIG. 4A which depicts an example historical dataset, in accordance with an embodiment. Specifically, FIG. 4A depicts four data rows of historical data, each data row including one or more parameter values for one or more parameters (e.g., parameters X, Y, and Z) that were used to previously train a machine learning model, an evaluation score (e.g., score 1, score 2, score 3, score 4) that indicates the performance of a machine learning model that was trained using the parameter values, and metadata (e.g., description 1, description 2, description 3, description 4) that is descriptive of static information corresponding to the machine learning model. As an example, static information about the machine learning model may include a type of event that the machine learning model is predicting (e.g., a click or a conversion) and/or an entity the machine learning model is trained for (e.g., a content provider system). Examples of events predicted by the machine learning model may be one of a web feed click through, off site conversion ratio (CVR) post click, 1 day sum session event bit, post like, video views, video plays, dwell time, store visits, checkouts, mobile app events, website visits, mobile app installs, purchase value, social engagement and the like. Additionally, the metadata can further include historical properties of the prior training dataset that was used to train the machine learning model that led to the corresponding evaluation score. The historical properties of the prior training dataset can include a total number of training examples, a rate of occurrence of the event, a mean occurrence of the event, a standard deviation of the occurrence of the event, and a type of the event to be predicted (e.g., web feed click through rate, off site conversion rate, 1 day sum session event bid, post like, video views, video plays, dwell time, store visits, checkouts, mobile app events, website visits, mobile app installs, purchase value, social engagement and the like).

In various embodiments, each data row corresponds to parameter values identified during a previous naïve parameter sweep and used to train a machine learning model. In some embodiments, a data row corresponds to parameter values identified by a prediction model and used to train a machine learning model. Although FIG. 4A shows an example with four data rows of historical data, more than four data rows of historical data may be retrieved by the parameter selection module 210 for determining candidate parameter values.

Given the historical dataset from the historical data store 250, the parameter selection module 210 first parses the historical dataset to identify data rows in the historical dataset that are relevant for training a machine learning model. For example, the machine learning model that is to be trained may be for a specific type of event, such as a click-through-rate (CTR) machine learning model that predicts whether an individual would interact (e.g., click) on a content item provided to the individual. Therefore, the parameter selection module 210 identifies data rows in the historical dataset that include a metadata description (e.g., description 1, description 2, description 3, or description 4) that is relevant and/or matches the type (e.g., CTR) of the machine learning model.

The parameter selection module 210 generates a prediction model including one or more parameter predictors based on the identified data in the historical dataset such that the prediction model can be used to predict candidate parameter values using the one or more parameter predictors. A prediction model may describe a relationship between a parameter and a property of prior training data of a historical dataset. Examples of a property of the prior training data include: a total number of training examples, statistical properties of the distribution of training labels over training examples (e.g., a maximum, a minimum, a mean, a mode, a standard deviation, a skew), attributes of a time series of training examples (e.g., time spanned by training examples, statistics of rate changes, Fourier transform frequencies, and date properties such as season, day of week, and time of day), attributes of the entity (e.g., industry category, entity content categorization, intended content audience demographics such as age, gender, country, and language, and quantitative estimates of brand awareness of this entity in intended audience demographics), attributes of the entity's past activity in the online system (which may indicate how well the online system may have had an opportunity to learn how to predict optimized events for this entity) (e.g., age of the entity's account, percentile of total logged events (e.g., pixel fires) from this entity), attributes of the online system at the time training examples were logged (e.g., utilized capacity and monitoring metrics that could indicate system malfunction like gross miscalibration of predicted events, open SEV tickets, and sudden drops in ad impressions or revenue), attributes of the optimized events or attributes of the entity's desired action represented by the optimized event (e.g., product categories for purchase event optimization, app event categorizations, and any attributes indicating changes to the optimized event in the training data including optimizing for one type of website or app event for a period followed by optimizing for a different category of website of app event and any attributes of mixtures or changes of optimized events in the training data), and attributes of the content depending on the content format (e.g., presence/absence of sound, is the same content being used throughout the training data or does the portfolio of creatives suddenly change).

Reference is now made to FIG. 4B, which depicts an example parameter predictor, in accordance with an embodiment. In this example, the parameter may be a learning rate and the property of the prior training dataset is the total number of training examples that was used to previously train the prior machine learning model.

Given the historical parameter values in the historical dataset, the parameter selection module 210 generates a parameter predictor that describes a relationship between the parameter (e.g., learning rate) and prior training dataset properties. The relationship may be a fit such as a linear, logarithmic, polynomial fit. For example, FIG. 4B depicts an inverse relationship such that with an increasing number of training examples, a lower learning rate can be applied when training the machine learning model. Therefore, given a value of training dataset property (such as a property from training dataset 270 shown in FIG. 2), the prediction model uses the parameter predictor to determine a corresponding value of the parameter. Instead of naively searching all available values for the learning rate, the parameter selection module 210 identifies a value of the learning rate based on the training dataset properties.

In various embodiments, the parameter selection module 210 generates one or more parameter predictors that incorporates the evaluation scores of the historical dataset in addition to the parameter and property of a prior training dataset, as depicted in FIG. 4C. Specifically, the evaluation scores may be represented as a third dimension of the parameter predictor. Therefore, given a value of the property of the training dataset, the prediction model can determine a value of the parameter while also considering the performance of prior machine learning models. In one embodiment, the identified value of the parameter corresponds to the property of training dataset that yielded a maximum evaluation score.

Generally, a parameter predictor generated by the parameter selection module 210 can be used to narrow the parameter space by removing certain parameter values that are unlikely to affect the training of the machine learning model and/or parameter values that would lead to a poorly performing machine learning model. Therefore, the parameter space used in conjunction with one or more parameter predictors includes a smaller number of possible combinations of parameter values in comparison to a parameter space used in a naïve parameter sweep.

Returning to FIG. 2, the parameter selection module 210 uses the one or more parameters predictors of a prediction model to determine candidate parameter values. In one embodiment, the prediction model identifies candidate parameter values based on training dataset properties. For example, the parameter selection module 210 receives training dataset 270 and extracts properties of the training dataset 270. Properties of the training dataset 270, hereafter referred to as training dataset properties, can include a total number of training examples, a rate of occurrence of the event, a mean occurrence of the event, a standard deviation of the occurrence of the event, and a type of the event to be predicted. Generally, the training dataset properties extracted from the training dataset 270 are the properties of prior training datasets that were used to generate the one or more parameter predictors. Therefore, the parameter selection module 210 uses the extracted training dataset properties to identify corresponding candidate parameter values using the relationships between candidate parameters and properties of training data described by the parameter predictors.

In some embodiments, the parameter selection module 210 can determine one or more candidate parameter values independent of the training dataset properties. As an example, the parameter selection module 210 identifies candidate parameter values based on the evaluation scores associated with the data rows of the historical dataset. In one embodiment, the prediction model predicts the impact of each individual parameter on the future training and performance of the machine learning model. The prediction model determines the impact of each parameter based on the evaluation scores from the historical dataset. For example, if a first data row includes parameter values of [X₁,Y₁,Z₁] and a second data row includes parameter values of [X₁,Y₁,Z₂], then the effect of changing the value of parameter Z from Z₁ to Z₂ can be determined based on the change in evaluation score from the first data row to the second data row. If the evaluation score change is below a threshold amount, the prediction model can determine that the parameter Z does not heavily impact the training and performance of the machine learning model. Alternatively, if the evaluation score change is above a threshold amount, then the prediction model can determine that the parameter Z heavily impacts the training and performance of the machine learning model. In determining candidate parameter values, the prediction model may assign a higher weight to parameters that heavily impact the training and performance of the machine learning model and assign a lower weight to parameters that minimally impact the training and performance of the machine learning model.

In some embodiments, the prediction model determines candidate parameter values based on the weights assigned to each parameter and the evaluation scores. As an example, first and second data rows of a historical dataset may be:

| Data Row | Parameters | Evaluation Score | Metadata |
|---|---|---|---|
| 1 | [X₁, Y₁] | Score 1 | Description 1 |
| 2 | [X₂, Y₂] | Score 2 | Description 2 |

Assuming the following example scenario: 1) Score 1 is preferable to Score2, 2) parameter X heavily impacts the training and performance of the machine learning model and is assigned a high weight, 3) Parameter Y does not heavily impact the training and performance of the machine learning model and is assigned a low weight.

In this example scenario, the prediction model identifies candidate parameter values [X_{candidate},Y_{candidate}], where candidate=1 or candidate=2, based on the evaluation scores (score 1 and score 2) as well as the weights assigned to each parameter. In one embodiment, given that Score 1 is preferable to Score 2, indicating that the parameters [X₁,Y₁] resulted in a better model performance than the parameters [X₂,Y₂], the prediction model may select X₁ as X_{candidate} because the assigned weight to parameter X is greater than the assigned weight to parameter Y. In another embodiment, the prediction model may perform one of an averaging or model fitting to calculate a value of X_{candidate} that falls between X₁ and X₂. Additionally, Y_{candidate} can be selected to be Y₁ because Score 1 is preferable to Score 2. In another embodiment, Y_{candidate} can be chosen to be a different value because its impact on the training and performance of the machine learning model is minimal. Although the example above depicts two parameters, X and Y, there may be numerous candidate parameters whose values are predicted by the prediction model.

In various embodiments, the parameter selection module 210 identifies candidate parameter values using a combination of the two aforementioned embodiments. Specifically, the parameter selection module 210 can determine a subset of values of the candidate parameters based on training dataset properties. As stated above, the parameter selection module 210 identifies and uses one or more parameter predictors. The parameter selection module 210 can further determine a subset of candidate parameter values independent of the training dataset properties. As described above, the parameter selection module 210 can weigh the impact of each candidate parameter and determine values of the candidate parameters according to the past evaluation scores.

The model training module 220 trains one or more machine learning models using the candidate parameter values identified by the parameter selection module 210. In various embodiments, a machine learning model is one of a decision tree, an ensemble (e.g., bagging, boosting, random forest), linear regression, Naïve Bayes, neural network, or logistic regression. In some embodiments, a machine learning model predicts an event of the online system 150. Here, a machine learning model can receive, as input, features corresponding to a content item and features corresponding to the user of the online system 150. With these inputs, the machine learning model can predict a likelihood of the event.

As depicted in FIG. 2, the model training module 220 receives the training dataset 270 from the training data store 190 and trains machine learning models using the training dataset 270. Different machine learning techniques can be used to train the machine learning model including, but not limited to decision tree learning, association rule learning, artificial neural network learning, deep learning, support vector machines (SVM), cluster analysis, Bayesian algorithms, regression algorithms, instance-based algorithms, and regularization algorithms. In some embodiments, the model training module 220 may withhold portions of the training dataset (e.g., 10% or 20% of full training dataset) and train a machine learning model on subsets of the training dataset. For example, the model training module 220 may train different machine learning models on different subsets of the training dataset for the purposes of performing cross-validation to further tune the parameters provided by the parameter selection module 210. In some embodiments, because candidate parameter values are selected by the parameter selection module 210 based on historical datasets, the tuning of the candidate parameter values may be significantly more efficient in comparison to randomly identified (e.g., naïve parameter sweep) candidate parameters values. In other words, the model training module 220 can tune the candidate parameter values in less time and while consuming fewer computing resources.

In various embodiments, training examples in the training data include 1) input features of a user of the online system 150, 2) input features of a content item, and 3) ground truth data indicating whether the user of the online system interacted (e.g., clicked/converted) on the content item. The model training module 220 iteratively trains a machine learning model using the training examples to minimize an error between a230 prediction and the ground truth data. The model training module 220 provides the trained machine learning models to the model evaluation module 230.

The model evaluation module 230 evaluates the performance of the trained machine learning models. As depicted in FIG. 2, the model evaluation module 230 may receive evaluation data 280. In various embodiments, the evaluation data 280 represents a portion of the training data obtained from the training data store 190. Therefore, the evaluation data 280 may include training examples that include 1) input features of a user of the online system 150, 2) input features of a content item, and 3) ground truth data indicating whether the user of the online system interacted (e.g., clicked/converted) with the content item.

In various embodiments, for each trained machine learning model, the model evaluation module 230 applies the examples in the evaluation data 280 and determines the performance of the machine learning model. More specifically, the model evaluation module 230 applies the features of a user of the online system 150 and the features of a content item as input to the trained machine learning model and compares the prediction to the ground truth data indicating whether the user of the online system interacted with the content item. The model evaluation module 230 calculates an evaluation score for each trained machine learning model based on the performance of the machine learning model across the examples of the evaluation data 280. In various embodiments, the evaluation score represents an error between the predictions outputted by trained machine learning model and the ground truth data. In various embodiments, the evaluation score is one of a logarithmic loss error or a mean squared error. The machine learning model associated with the best evaluation score may be selected to be entered into production.

The model evaluation module 230 may compile the evaluation scores determined for the various trained machine learning models. As one example, referring again to FIG. 4, the model evaluation module 230 may generate the historical dataset that includes the evaluation score of each trained machine learning model as well as the corresponding set of candidate parameter values (now historical parameter values) that was used to train each machine learning model. As shown in FIG. 2, the model evaluation module 230 can store the historical datasets in the historical data store 250 which can then be used in subsequent iterations of determining candidate parameter values for training additional machine learning models.

### Validating a Prediction Model or Trained Machine Learning Model

The online system 150 can validate a prediction model that is used to identify parameters for training a machine learning model and/or the online system 150 can validate a trained machine learning model.

In various embodiments, the model generation module 160 validates a prediction model by validating the training examples that are used to generate the prediction model. For example, while using the properties of training examples in the training dataset 270, the model generation module 160 validates whether each training example is likely to be predictive. As a specific example, if a training example corresponds to an event (e.g., clicks) with an image, but future content items are to include videos instead of images, then that training example can be discarded. Therefore, the prediction model that describes the relationship between a parameter and a property of the training examples is relevant for future content items.

The online system 150 also validates a machine learning model to ensure that the machine learning model is behaving as expected. Reference is now made to FIG. 3, which depicts a block diagram flow process for validating the trained machine learning model, in accordance with an embodiment. In other words, FIG. 3 depicts a process in which the online system 150 can detect when a machine learning model that was trained using candidate parameter values identified by the prediction model is no longer performing as expected. In various embodiments, in response to detecting that the machine learning model is no longer performing as expected, new parameters for training a machine learning model can be identified. In one embodiment, in response to the detection, a naïve parameter sweep is executed using one of grid search or random parameter search.

FIG. 3 depicts various elements of the online system 150 that may execute their respective processes at various times. In one embodiment, the various elements of the online system 150 for validating a trained machine learning model include the parameter selection module 210, which generates and/or employs a prediction model 340, the model training module 220, the model application module 170 and the error detection module 180.

As described above, the prediction model 340 used by the parameter selection module 210 may receive historical datasets that includes sets of historical parameters 305, an evaluation score 310, and corresponding metadata 315. An example of a historical dataset is described above and in reference to FIG. 4A.

In various embodiments, the prediction model 340 can generate an estimated performance 325 that corresponds to the candidate parameter values provided to the model training module 220. As an example, the estimated performance 325 may be a numerical mean and standard deviation that represents the expected performance of a machine learning model that is trained using the candidate parameter values. More specifically, if the machine learning model predicts the probability of an event (e.g., a click or conversion), the estimated performance 325 may be a mean error of the predicted event and a standard deviation of the error of the predicted event. In some embodiments, the prediction model 340 calculates the estimated performance 325 using the evaluation scores 310 from the historical dataset. For example, if the prediction model 340 identifies particular historical parameters 305 e.g., Xₐ, Yₐ, Zₐ, as the candidate parameter values that are to be provided to the model training module 220, the prediction model 340 may derive the estimated performance 325 from the evaluation score 310 corresponding to the historical parameters 305. More specifically, the prediction model 340 can calculate an average and standard deviation of all evaluation scores 310 that have applicable metadata 315 and correspond to the particular historical parameters 305, e.g., Xₐ, Yₐ, Zₐ. Thus, the average and standard deviation of the identified evaluation scores 310 may be the estimated performance 325 that, as shown in FIG. 3, is provided to the error detection module 180.

As shown in FIG. 3 and as described above, the prediction model 340 identifies candidate parameter values and provides them to the model training module 220 that trains the machine learning model. After training, the machine learning model can be retrieved by the model application module 170. In various embodiments, the trained machine learning model is retrieved during production and used to make predictions as to the likelihood of various events, such as a click or conversion by a user of the online system 150.

In one embodiment, the model application module 170 receives a content item 330 and user information 335 associated with a user of the online system 150. The model application module 170 evaluates whether the content item 330 is to be presented to the user of the online system 150 by applying the trained machine learning model. In one embodiment, the model application module 170 may perform a feature extraction step to extract features from the content item 330 and features from the user information 335. Various features can be extracted from the content item 330 which may include, but is not limited to: subject matter of the content item 330, color(s) of an image, length of a video, identity of a user that provided the content item 330, and the like. Various features can also be extracted from the user information 335 including, but is not limited to: personal information of the user (e.g., name, physical address, email address, age, and gender), user interests, past activity performed by the user, and the like. In various embodiments, the model application module 170 constructs one or more feature vectors including features of the content item 330 and features of the user information 335. The feature vectors are provided as input to the trained machine learning model.

In some embodiments, the content item 330 and the user information 335 is provided to a machine learning model that performs the feature extraction process. For example, a deep learning neural network may learn the features that are to be extracted from the content item 330 and user information 335.

The trained machine learning model generates a predicted output 355. In one embodiment, the predicted output 355 is a likelihood of the user of the online system 150 interacting with the content item 330. As an example, the machine learning model may calculate a predicted output 355 of 0.6, indicating that there is a 60% likelihood that the user of the online system 150 will interact with the content item 330. In various embodiments, if the predicted output 355 is above a threshold score, the content item 330 is provided to the user of the online system 150.

The model application module 170 provides the predicted output 355 to the error detection module 180. In various embodiments, the error detection module 180 also receives an actual output 345. For example, the online system 150 can detect that the user of the online system 150 interacted with the presented content item 330. In one embodiment, the actual output 345 is assigned a numerical value (e.g., “1”) if an interaction is detected whereas the actual output 345 is assigned a different numerical value (e.g., “0”) if an interaction is not detected.

The error detection module 180 validates whether the machine learning model is still performing as expected based on the estimated performance 325 from the prediction model 340, the predicted output 355 generated by the trained machine learning model, and the detected actual output 345. In various embodiments, the error detection module 180 calculates the difference between the predicted output 355 and the actual output 345, the difference hereafter termed the prediction error. The prediction error is a representation of the performance of the trained machine learning model. In various embodiments, the error detection module 180 evaluates the prediction error against the estimated performance 325. If the prediction error is within a threshold value of the estimated performance 325, the error detection module 180 can deem the machine learning model as performing as expected. As an example, the estimated performance 325 may be an estimated error of a mean click through rate of 10% with a standard deviation of 3%. Therefore, if the error detection module 180 calculates a prediction error of 8%, which is within a threshold (e.g., within one or two standard deviations) of the mean click through rate, then the machine learning model is performing as expected.

Alternatively, if the prediction error exceeds a threshold value of the estimated performance 325, the error detection module 180 can deem the machine learning model as performing unexpectedly. In this embodiment, the historical dataset used by the prediction model 340 to predict the candidate parameter values may no longer be applicable. In one embodiment, the trained machine learning model is pulled and a different model can be applied. In another embodiment, the error detection module 180 can trigger a new parameter sweep (e.g., through grid search or random parameter search) to determine new candidate parameter values for training the machine learning model.

### Process of Training and Applying a Machine Learning Model

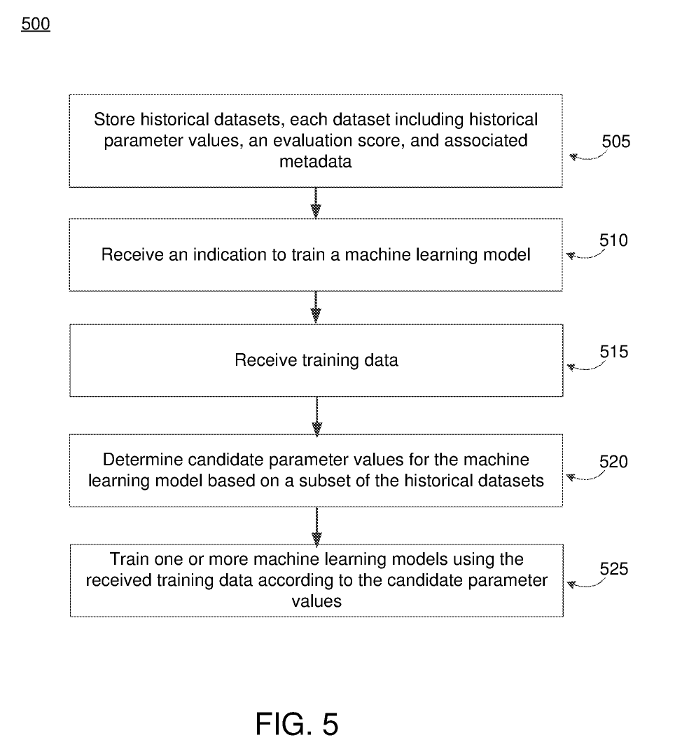

FIG. 5 depicts an example flow process for training a machine learning model, in accordance with an embodiment. The online system 150 stores 505 historical datasets in the historical data store 250. Each stored dataset includes various information including historical parameters, an evaluation score corresponding to the performance of a machine learning trained using the historical parameters, and associated metadata that includes static information descriptive of the machine learning model.

The online system 150 receives 510 an indication (e.g., a request) to train a machine learning model. As an example, a new machine learning model may be implemented for a new entity (e.g., a new advertiser) that requires a particular type of prediction. Therefore, the online system 150 receives the indication to train a new machine learning model for the new entity. As another example, a machine learning model that was previously in production may need to be retrained, and as such, the online system 150 receives the indication that the machine learning model needs to be retrained. The online system 150 receives 515 the training data that is to be used to train the machine learning model.

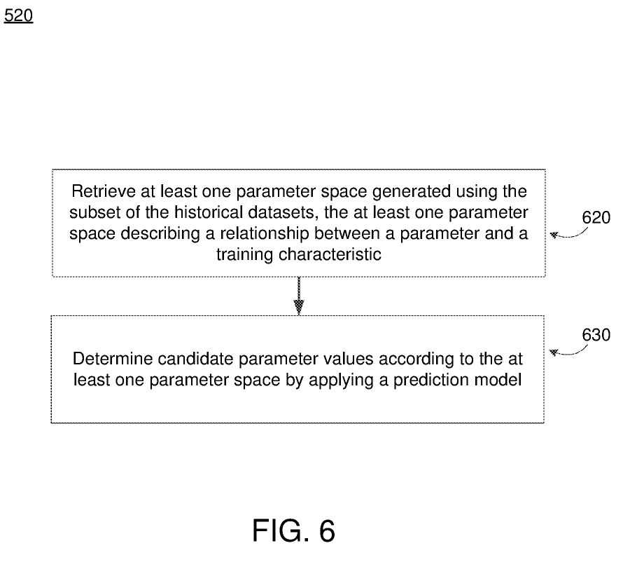

The online system 150 determines 520 candidate parameter values for the machine learning model based on a subset of the historical datasets. For example, in various embodiments, the online system 150 only identifies candidate parameter values using historical datasets with associated metadata information that appropriately describes the machine learning model that is to be trained. Reference is now made to FIG. 6, which depicts an example flow process of determining candidate parameter values for a machine learning model (e.g., step 520 of FIG. 5), in accordance with an embodiment. The online system 150 retrieves 620 at least one parameter predictor that was generated using the subset of historical datasets. In various embodiments, the at least one parameter predictor describes a relationship between a parameter and a property of the training dataset. Therefore, the online system 150 determines 630 candidate parameter values according to the predicted at least one parameter predictor.

Returning to FIG. 5, using the candidate parameter values, the online system 150 trains 525 one or more machine learning models. In various embodiments, each machine learning model may be a different type of model (e.g., random forest, neural network, support vector machine, and the like). Therefore, the online system 150 may train each machine learning model using all or a subset of the identified candidate parameter values.

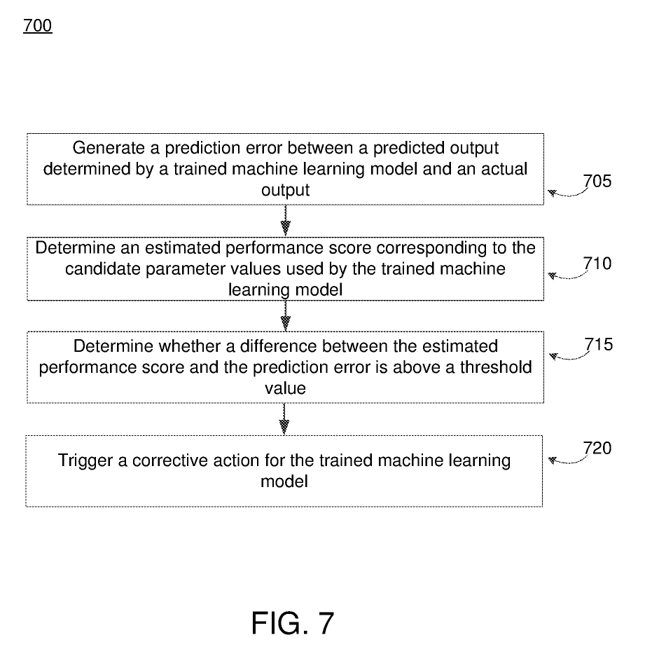

FIG. 7 depicts an example flow process of validating a trained machine learning model, in accordance with an embodiment. The online system 150 generates 705 a prediction error between a predicted output determined by the trained machine learning model and an actual output. The online system 150 determines 710 an estimated performance score corresponding to the candidate parameter values used by the trained machine learning model. In various embodiments, the estimated performance score is outputted by the prediction model 340. The online system 150 determines 715 whether a difference between the estimated performance score and the prediction error is above a threshold value. If so, the online system 150 triggers 720 a corrective action for the trained machine learning model. In one embodiment, the online system 150 replaces the machine learning model currently in production with a different machine learning model that is performing as expected. In some embodiments, the online system 150 performs a naïve parameter sweep (e.g., grid search or random parameter search) to determine a new set of candidate parameter values to re-train the machine learning model.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, by an online system, a plurality of historical datasets, each historical dataset comprising historical parameter values used to train a prior machine learning model, an evaluation score representing a performance of the prior machine learning model, and associated metadata descriptive of the prior machine learning model;
receiving a request to train a machine learning model;
predicting candidate parameter values for training the machine learning model, the candidate parameter values predicted based on a subset of the plurality of historical datasets;
receiving training data for training the machine learning model; and
training the machine learning model using the received training data according to the predicted candidate parameter values.

2. The method of claim 1, wherein determining candidate parameter values comprises:
identifying at least one parameter predictor associated with a relationship between one or more parameters and a training dataset property; and
determining candidate parameters based on the at least one parameter predictor by applying a prediction model.

3. The method of claim 2, wherein each of the one or more training dataset properties is one of a total number of training examples, statistical properties of a distribution of training labels over training examples, attributes of a time series of training examples, attributes of an entity, attributes of past activity performed by the entity, attributes of the online system, and attributes of an event predicted by the machine learning model.

4. The method of claim 1, wherein determining candidate parameter values comprises:
for each candidate parameter, assigning a weight to the candidate parameter, the weight representing an impact of the candidate parameter on the performance of the prior machine learning model; and
determining a value for each candidate parameter based on the weight assigned to the candidate parameter and one or more evaluation scores in the subset of the plurality of historical datasets.

5. The method of claim 1, wherein the subset of the plurality of historical datasets is identified by comparing the associated metadata of the prior machine learning model to information describing the machine learning model.

6. The method of claim 1, wherein the machine learning model generates a predicted output, wherein the predicted output corresponds to a likelihood of occurrence of a user interaction performed by a user of the online system on a content item.

7. The method of claim 6, further comprising generating an evaluation score for the trained machine learning model based on a comparison between the predicted output from the prediction model and ground truth data from evaluation data.

8. A non-transitory computer-readable medium comprising computer program code, the computer program code when executed by a processor of a client device causes the processor to:
store, by an online system, a plurality of historical datasets, each historical dataset comprising historical parameter values used to train a prior machine learning model, an evaluation score representing a performance of the prior machine learning model, and associated metadata descriptive of the prior machine learning model;
receive a request to train a machine learning model;
predict candidate parameter values for training the machine learning model, the candidate parameter values predicted based on a subset of the plurality of historical datasets;
receive training data for training the machine learning model; and
train the machine learning model using the received training data according to the predicted candidate parameter values.

9. The non-transitory medium of claim 8, wherein the computer program code to determine candidate parameters further comprises computer program code that when executed by the processor causes the processor to:
identify at least one parameter predictor associated with a relationship between one or more parameters and a training dataset property; and
determine candidate parameters based on the at least one parameter predictor by applying a prediction model.

10. The non-transitory medium of claim 9, wherein each of the one or more training dataset properties is one of a total number of training examples, statistical properties of a distribution of training labels over training examples, attributes of a time series of training examples, attributes of an entity, attributes of past activity performed by the entity, attributes of the online system, and attributes of an event predicted by the machine learning model.

11. The non-transitory medium of claim 8, wherein the computer program code to determine candidate parameters further comprises computer program code that when executed by the processor causes the processor to:
for each candidate parameter, assign a weight to the candidate parameter, the weight representing an impact of the candidate parameter on the performance of the prior machine learning model; and
determine a value for each candidate parameter based on the weight assigned to the candidate parameter and one or more evaluation scores in the subset of the plurality of historical datasets.

12. The non-transitory medium of claim 8, wherein the subset of the plurality of historical datasets is identified by comparing the associated metadata of the prior machine learning model to a type of the machine learning model.

13. The non-transitory medium of claim 8, wherein the machine learning model generates a predicted output, wherein the predicted output corresponds to a likelihood of occurrence of a user interaction performed by a user of the online system on a content item.

14. The non-transitory medium of claim 13, further comprising code that when executed by the processor of a client device causes the processor to:
generate an evaluation score for the trained machine learning model based on a comparison between the predicted output from the prediction model and ground truth data from evaluation data.

15. A method comprising:
determining an estimated performance score of a trained machine learning model that was trained using candidate parameter values predicted by a prediction model;
generating a prediction error based on a difference between a predicted occurrence of an event obtained from the trained machine learning model and an actual output;
determining that a difference between the estimated performance score and the generated prediction error exceeds a threshold error; and
responsive to the determined difference being above the threshold error, triggering a corrective action for the trained prediction model.

16. The method of claim 15, wherein generating the prediction error comprises:
applying features of a user of an online system and features of a content item as input to the trained machine learning model to obtain a predicted output;
presenting the content item to the user of the online system based on the predicted output;
responsive to presenting the content item, receiving the actual output indicating whether the event occurred; and
comparing the predicted output of the trained machine learning model to the received actual output to generate a prediction error.

17. The method of claim 15, wherein the estimated performance score comprises an expected mean and expected standard deviation of an expected error, and wherein the threshold error is based on the expected standard deviation of the expected error.

18. The method of claim 15, wherein a subset of the candidate parameters predicted by the prediction model are identified based on at least one parameter predictor generated from historical datasets comprising historical parameter values.

19. The method of claim 18, wherein the at least one parameter predictor predicted by a prediction model describes a relationship between a parameter and a training dataset property extracted from training data that the machine learning model was previously trained on.

20. The method of claim 15, wherein the triggered corrective action is one of removal of the trained machine learning model from a production system or determining new candidate parameter values to re-train the machine learning model using one of: a grid search or random parameter search.
